(19) United States
(12) Patent Application Publication
(10) Pub. No.: US 2026/0003772 A1
(43) Pub. Date: Jan. 1, 2026

(54) Method for generating a fuzzing harness

(71) Applicants: CONTINENTAL AUTOMOTIVE TECHNOLOGIES GMBH, Hannover (DE); NANYANG TECHNOLOGICAL UNIVERSITY, Singapore (SG)

(72) Inventors: Siyang XIONG, Singapore (SG); Yuekang LI, Singapore (SG); Cen ZHANG, Singapore (SG); Chaoyi LIU, Singapore (SG)

(21) Appl. No.: 18/879,611

(22) PCT Filed: Jun. 14, 2023
(86) PCT No.: PCT/EP2023/066022

§ 371 Date: Dec. 27, 2024

(30) Foreign Application Priority Data
Jun. 29, 2022 (DE) 10 2022 116 237.0

(51) Int. Cl. G06F 11/3668; G01M 17/00

(52) U.S. Cl. CPC G06F 11/3696; G01M 17/00; G06F 11/3684

(57) ABSTRACT

The invention relates to a method (1) for generating a fuzzing harness (10). According to the method (1), a piece of software source code (2) is provided. A target function (3) to be fuzzed and a sample program (5) that calls the target function (3) are selected from the software source code (2). The sample program (5) is then compiled to generate bit code (8) and the target function (3) is sliced from the bit code (8), based on the target function (3), to obtain the fuzzing harness (10). The invention further relates to a computer program product 10 comprising instructions which, when executed by a computer, cause the computer to perform the method (1) described above.

### TECHNICAL FIELD

The invention relates to a method for generating a fuzzing harness using a sample program that calls a target function to be fuzzed. The invention further relates to a computer program that, when executed by a computer, causes the computer to generate a fuzzing harness.

### BACKGROUND

Software analysis is an important task in the development of automotive software due to the automotive industry's high standard of ensuring software quality for its safety-critical mission. In addition to the safety requirement, the recent introduction of security compliance requirements in automotive software also demands automotive software to be thoroughly analyzed to remove potential security vulnerabilities.

Software analysis has been introduced into the software development process since a long time ago and software analysts keep improving the effectiveness and efficiency of the analysis process. Among categories of software analyses, dynamic analysis is gaining popularity in the software community. Instrumented fuzzing is one of the methods in dynamic analysis. Instrumented fuzzing has a fuzzing engine which generates random inputs to the software to be fuzzed, trying to reveal the vulnerability in the software. To adopt instrumented fuzzing as a software analysis methodology, one needs to create a fuzzing harness which connects the fuzzing engine to the fuzz target. Software developers or testers with little fuzz testing background need considerable amount of ramp-up effort to understand how to write the fuzzing harness. Hence, an automation of the harness generation is needed to reduce such ramp-up effort.

In particular, a fuzzing harness is a test case or a particular test target. It is an “entry point executable” to the fuzz target and connects random inputs from an input generation engine to the fuzz target. When a tester wants to pass the random data to a specific part of the fuzz target, he or she needs to create the fuzzing harness. In other words, the fuzzing harness can decide the analysis coverage, i.e., enabling the random input to reach every part of the fuzz target.

For example, if one wants to assess the security of the server application in a client-server architecture, he or she needs a testing harness to perform various setup tasks, like starting the server process prior to sending network input (i.e., the random input) from a client connection. Another example would be testing a Dynamically Loaded Library (DLL). Since the DLL cannot run independently on its own, one would need to write a fuzzing harness, in this case an executable program using the DLL that passes input from a command line into DLL functions.

To prepare a fuzzing harness, the source code of the fuzz target has to be retrieved from a software version control system. Further, a sample program, or a consumer program, which uses the fuzz target has to be retrieved. Then it has to be examined how the fuzz target is used in the sample program, the outcome of which is called the trace information. Creating trace information could be done via either dynamic tracing, e.g., function execution trace via running the program, or static tracing, e.g., function call trace via scanning the source code. Then, the trace information is used to create the test harness. The tasks include getting the calling trace information of the target function, parsing the target function, and creating a test logic out of the information collected. The above procedure can be tedious and time-consuming if all is done manually. An alternative is semi-automatically converting the trace information to the test logic, wherein a user needs to select the suitable harness out of the given choices from the generation from a tool.

An example of automated test logic generation in fuzzing is given in the article “FUDGE: Fuzz Driver Generation at Scale” by D. Bucur et al. (https://doi.org/10.1145/3338906.3340456). Another example of automated fuzzer generation is given in the article “FuzzGen: Automatic Fuzzer Generation” by K. Ispoglou et al. (Proceeding of the 29^{th} USENIX Security Symposium, 2020).

### SUMMARY

It is an object of the present invention to provide an improved method for generating a fuzzing harness. It is another object of the present invention to provide a computer program comprising instructions that, when executed by a computer, perform the improved method for generating a fuzzing harness.

The object of the present invention is solved by the subject-matter of the independent claims, wherein further embodiments are incorporated in the dependent claims.

According to an aspect of the invention, a method for generating a fuzzing harness is provided. In this context, fuzzing may also be referred to as robustness testing, fuzz testing or negative testing.

According to the method, a piece of software source code is provided. Said software source code comprises the source code for the software that is to be tested. From the software source code, a target function to be fuzzed is selected. Said selection of the target function may be performed manually, i.e., by a user. The selection of the target function may also be performed automatically, wherein out of the plurality of functions in the software source code, a target function may be chosen based on its occurrence in the source code or based on a date on which the target function is created.

Further, a sample program is selected from the software source code, wherein said sample program calls the target function. The sample program may be part of a test suite for the software, but it may also be a non-testing consumer program. If more than one sample programs can be identified that call the target function, the method may be repeated for more than one of said sample programs, or a sample program may be chosen, e.g., based on the size of the sample program, where a smaller sample program is to be preferred.

Once the target function and the sample program have been chosen, the sample program is compiled to generate bit code, e.g., with a file extension “.bc”.

From said bit code, the target function is sliced. For the slicing, the desired target function is provided to the slicer. The result of said slicing is the fuzzing harness that may be used to test the target function. In slicing the target function from the bit code, parts of the bit code that are not related to the target function are removed, hence less computing resources such as memory and/or CPU time are needed.

With the presented method for generating the fuzzing harness, a quality of the generated fuzzing harness is ensured, since the method does not depend on the skill of a user. In addition, time is saved by applying the method, since the tedious work of generating a fuzzing harness is now automated. Finally, it is sufficient to let developers without special software analysis skills generate the fuzzing harness with the above method, hence highly-skilled developers are no longer needed for this task.

According to an embodiment, the software source code is source code of software for a vehicle, in particular a vehicle with an Advanced Driver Assistance System (ADAS), more particularly an autonomous vehicle. In these cases, accurately testing the software and removing bugs and vulnerabilities might save lives, since bugs in the ADAS or the autonomous vehicle may lead to, in the worst case, casualties in vehicle crashes.

According to an embodiment, after selecting the target function, external dependencies of the target function are identified. The external dependencies are functions that are used by the target function, and which are not of interest for the analysis. Slicing the target function is then further based on said external dependencies.

According to an embodiment, a dataflow of at least one of the external dependencies is modeled. That is, slicing may be performed by using said modeled dataflow instead of the external dependency itself. This enables a more precise and more effective slicing of the program.

According to an embodiment, at least one of the external dependencies is replaced by a stub implementation of the external dependency. In particular external dependencies that would require a large integration effort in order to include them may be replaced by a stub implementation. Slicing the target function from the bit code is then also dependent on the stub implementation.

According to an embodiment, the method further comprises identifying an entry point of the sample program that will lead to the call of the target function. This step is performed after selecting the sample program and before compiling the sample program. Compiling the sample program is then performed starting from said entry point. Hence, program code before the entry point, which does not affect the call of the target function, is already omitted in compiling the sample program, further saving computing resources.

According to an embodiment, the sample program is a multi-threaded program. In this case, identifying the entry point comprises identifying other functions in the multiple threads that need to be called before entering the entry point. Hence, for each of the threads, there may be a separate thread-specific entry point, and compiling the sample program may start from each of said thread-specific entry points for each of the threads.

According to an embodiment, the bit code is LLVM bit code, i.e., a virtual machine bit code. LLVM bit code is very versatile and well suited for generating fuzzing harnesses. In this case, the compiler wllvm may be used, in particular replacing the standard compiler for the sample program such as gcc or clang. As a slicer, the llvm-slicer may be used. Also, for modeling the external dependencies, the functionModelAddUse API may be used.

According to an embodiment, the method further comprises reverting the fuzzing harness back to a source code file yielding a harness source. Hence, the harness source is the source code for the sliced program. In particular, the source code file is a human readable code, such as a c file. The harness source is then reviewed and modified, in particular by a user. Since during slicing, symbol information of the variables is not retained, symbols are presented by “var1”, “var2”, and so on in the reverted source code. Then the modified harness source is compiled to generate a modified fuzzing harness, which is improved compared to the original fuzzing harness.

According to an embodiment, the method further comprises fuzzing the target function using the fuzzing harness. That is, the target function is provided with random input data, via the fuzzing harness, and hence potential bugs in the target function may be detected. Once such a bug has been detected, it has to be further analyzed and then patched, which is usually done by experienced developers. As a result, the target function has fewer bugs, becomes more stable, more reliable and less prone to attacks.

According to another aspect of the present invention, a computer program product is provided. The computer program product comprises instructions which, when executed by a computer, causes the computer to perform the steps according to the above description. The technical advantages of said computer program product correspond to those of the method and are explained in detail above.

### BRIEF DESCRIPTION OF THE DRAWINGS

These and other aspects of the invention will be apparent from and elucidated further with reference to the embodiments described by way of examples in the following description and with reference to the accompanying drawings, in which

FIG. 1 shows a flowchart of an embodiment of a method for generating a fuzzing harness;

FIG. 2 shows a flowchart of another embodiment of a method for generating a fuzzing harness; and

FIG. 3 shows a flowchart of yet another embodiment of a method for generating a fuzzing harness.

In the figures, elements which correspond to elements already described may have the same reference numerals. Examples, embodiments or optional features, whether indicated as non-limiting or not, are not to be understood as limiting the invention as claimed.

### DESCRIPTION OF EMBODIMENTS

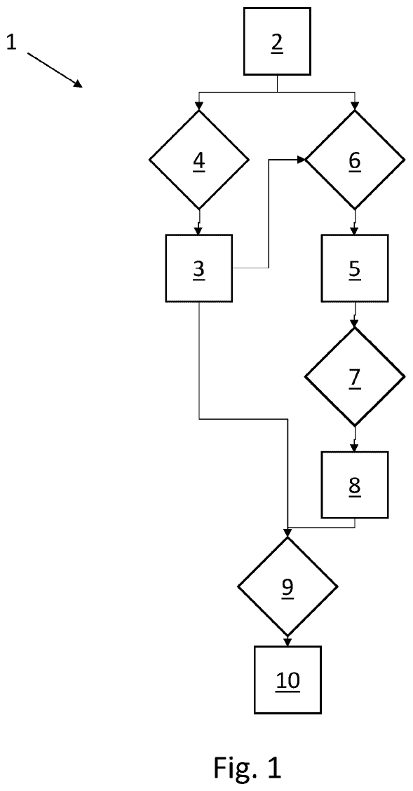

FIG. 1 shows a flowchart of an embodiment of a method 1 for generating a fuzzing harness. According to the method 1, software source code 2 is provided. From said software source code 2, a target function 3 to be fuzzed is selected 4. Said selection may be performed manually or based on certain rules, e.g., target function 3 that are extensively used in the software source code 2 are selected first. Also, a sample program 5 that calls the target function 3 is selected 6 from the software source code 2. The sample program 5 is then compiled 7 to generate bit code 8. From the bit code 8, the target function 3 is sliced 9, to obtain the fuzzing harness 10.

With the method 1 for generating the fuzzing harness 10, a quality of the generated fuzzing harness 10 is ensured, since the method does not depend on the skill of a user. Also, time is saved by applying the method 1, since the tedious work of generating a fuzzing harness 10 is now automated. Finally, developers without special software analysis skills are sufficient to generate the fuzzing harness 10 with the above method 1, hence highly skilled developers are no longer needed for this task.

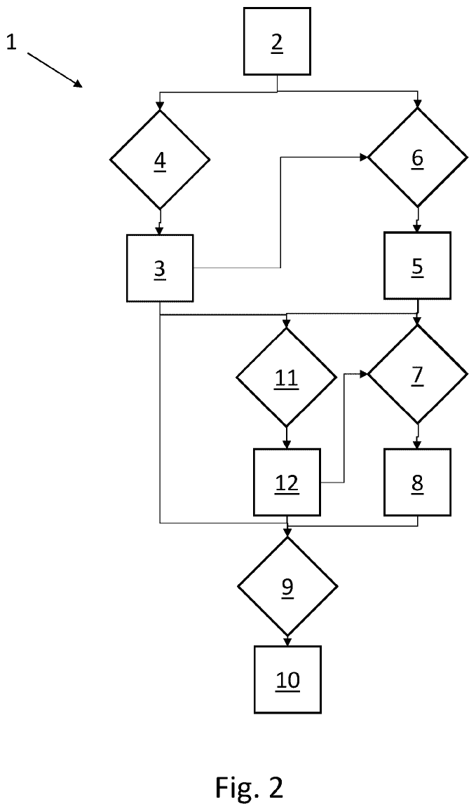

FIG. 2 shows a flowchart of another embodiment of a method 1 for generating a fuzzing harness 10. In comparison with the method 1 of FIG. 1, this method further comprises a step of identifying 11 external dependencies 12 of the target function 3. For said external dependencies 12, the dataflow may be modeled and/or the external dependencies 12 may be replaced by a stub implementation.

In either case, the results will be used to generate the bit code 8 and to perform the slicing 9. As a result, the fuzzing harness 10 is smaller and requires less computing resources such as memory and/or CPU time.

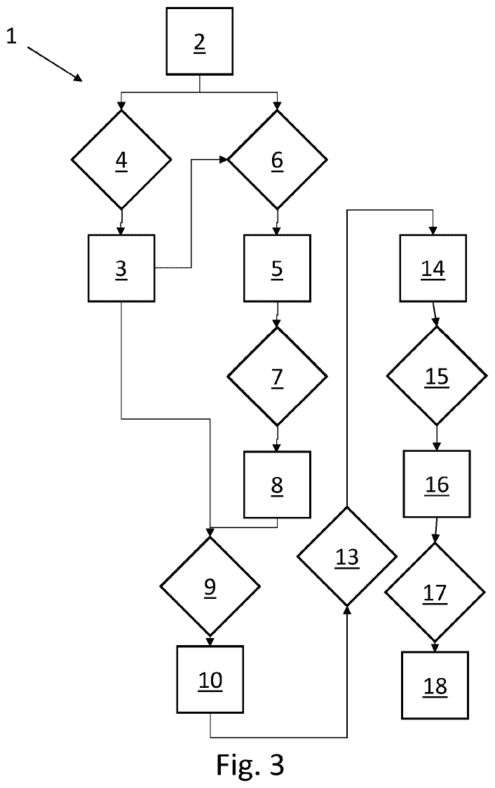

FIG. 3 shows a flowchart of yet another embodiment of a method 1 for generating a fuzzing harness 10. In comparison with the method 1 of FIG. 1, the fuzzing harness 10 is reverted 13 back to a source code file yielding a harness source 14. Said harness source 14 may then be review and modified 15, in particular by an experienced developer, to create a modified harness source 16. Finally, the modified harness source 16 is compiled 17 to generate a modified fuzzing harness 18, which is improved in comparison to the original fuzzing harness 10.

Other variations to the disclosed embodiments can be understood and effected by those skilled in the art in practicing the claimed invention, from the study of the drawings, the disclosure, and the appended claims. In the claims the word “comprising” does not exclude other elements or steps and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope of the claims.

1-11. (canceled)

12. A method for generating a fuzzing harness, the method comprising:
providing software source code;
selecting a target function to be fuzzed from the software source code;
selecting a sample program from the software source code that calls the target function;
compiling the sample program to generate a bit code; and
slicing the target function from the bit code based on the target function to obtain the fuzzing harness.

13. The method according to claim 12, wherein the software source code is code of software for a vehicle.

14. The method according to claim 13, wherein the vehicle is provided with an advanced driver assistance system.

15. The method according to claim 13, wherein the vehicle is an autonomous vehicle.

16. The method according to claim 12, further comprising after selecting the target function and selecting the sample program, identifying external dependencies of the target function, and further slicing the target function based on the external dependencies.

17. The method according to claim 16, further comprising modelling a dataflow of at least one of the external dependencies.

18. The method according to claim 16, further comprising replacing at least one of the external dependencies by a stub implementation of the at least one of the external dependency.

19. The method according to claim 12, further comprising, after selecting the sample program and before compiling the sample program, identifying an entry point of the sample program that will lead to the calling of the target function, wherein the compiling of the sample program is performed starting from the entry point.

20. The method according to claim 19, wherein the sample program is a multi-threaded program, and wherein the identifying the entry point comprises identifying other functions in the multiple threads to be called before entering the entry point.

21. The method according to claim 12, wherein the bit code is a LLVM bit code.

22. The method according to claim 12, further comprising:
reverting the fuzzing harness back to a source code file yielding a harness source;
reviewing and modifying the harness source; and
compiling the modified harness source to generate a modified fuzzing harness.

23. The method according to claim 12, further comprising fuzzing the target function using the fuzzing harness.

24. A non-transitory computer-accessible medium which includes computer software that comprises instructions which, when executed by a computer, cause the computer to perform the procedures comprising:
providing software source code;
selecting a target function to be fuzzed from the software source code;
selecting a sample program from the software source code that calls the target function;
compiling the sample program to generate a bit code; and
slicing the target function from the bit code based on the target function to obtain the fuzzing harness.

25. The computer-accessible medium according to claim 24, wherein the software source code is code of software for a vehicle, wherein the vehicle is provided with an advanced driver assistance system, and wherein the vehicle is an autonomous vehicle.

26. The computer-accessible medium according to claim 24, wherein the computer is further configured to, after selecting the target function and selecting the sample program, identify external dependencies of the target function, and further slice the target function based on the external dependencies.

27. The computer-accessible medium according to claim 26, wherein the computer is further configured to model a dataflow of at least one of the external dependencies.

28. The computer-accessible medium according to claim 26, wherein the computer is further configured to replace at least one of the external dependencies by a stub implementation of the at least one of the external dependency.

29. The computer-accessible medium according to claim 22, wherein the computer is further configured to, after selecting the sample program and before compiling the sample program, identify an entry point of the sample program that will lead to the calling of the target function, wherein the compiling of the sample program is performed starting from the entry point.

30. The computer-accessible medium according to claim 29, wherein the sample program is a multi-threaded program, and wherein the identifying the entry point comprises identifying other functions in the multiple threads to be called before entering the entry point.

31. The computer-accessible medium according to claim 22, wherein the bit code is a LLVM bit code.

32. The computer-accessible medium according to claim 22, wherein the computer is further configured to:
reverting the fuzzing harness back to a source code file yielding a harness source;
reviewing and modifying the harness source; and
compiling the modified harness source to generate a modified fuzzing harness.

33. The computer-accessible medium according to claim 32, further comprising fuzzing the target function using the fuzzing harness.
